(19) United States
(12) Patent Application Publication
(10) Pub. No.: US 2025/0123150 A1
(43) Pub. Date: Apr. 17, 2025

(54) SYSTEMS AND METHODS FOR WIRELESSLY PROBING FOOD

(71) Applicant: RENAU CORPORATION, CHATSWORTH, CA (US)

(72) Inventor: KAROL RENAU, Calabasas, CA (US)

(21) Appl. No.: 18/919,273

(22) Filed: Oct. 17, 2024

Related U.S. Application Data
(60) Provisional application No. 63/648,980, filed on May 17, 2024.
(60) Provisional application No. 63/544,587, filed on Oct. 17, 2023.

(51) Int. Cl. G01K 1/024

(52) U.S. Cl. CPC G01K 1/024; G01K 2207/06; G01K 2215/00

(57) ABSTRACT

The instant invention provides for a wireless food probe utilizing Bluetooth Low Energy and, optionally, an accompanying charging station. The food probe is able to produce its required power for temperature measurement and wireless communications based on differential temperature inside the food item and the ambient temperature inside the heating cabinet. The food probe generally includes one or more resistance temperature detectors and a thermopile or Peltier. Some embodiments of the present invention further include an accompanying charging station utilizing transmitting coils for charging the probe. In such embodiments, the probe includes a receiving coil and is chargeable by the charging station using induction. The probes are capable of utilizing either or both power methods as needed. The probe device communicates with any Bluetooth enabled device or controller, such as an application on a mobile phone that can be used to receive live cooking information.

### CROSS-REFERENCE TO RELATED APPLICATIONS

This application claims priority to U.S. Provisional Patent Application Ser. No. 63/648,980, filed May 17, 2024, and U.S. Provisional Patent Application Ser. No. 63/544,587, filed Oct. 17, 2023, the entire disclosures of which are incorporated herein by reference.

### FIELD OF THE INVENTION

The present invention relates generally to food cooking systems and methods. The present invention further relates to temperature measurement and monitoring potential cooking hazards, including those identified by the Food and Drug Administration's Hazard Analysis Critical Control Point (HACCP) system. More specifically, the present invention is concerned with systems and measurements for wirelessly probing and monitoring food and notifying and/or alerting a user based upon the measurements.

### BACKGROUND OF THE INVENTION

In the commercial food industry, internal temperature measurement is a key aspect of food quality and safety. Most raw foods need to be cooked to a certain internal temperature to be eaten safely. Therefore, meat and/or food thermometers have become common in the industry.

Traditional food thermometers present many issues. The operator must guess when to take the food out of the oven or other cooking element in order to insert the thermometer. Valuable cooking time is lost and the temperature of the food will decrease while the cooking is paused for measurement. In some cases, the intermittent pause in cooking also affects the quality of the food. Furthermore, the operator must make their notes of the temperatures over time, typically on a piece of paper. In some instances, the temperature curve over time must be logged and saved in order to ensure quality of the food and compliance with HACCP or other regulations. The logs must also be stored for inspection at any time. This requires tedious amounts of work from the operator to continually log and store the information.

Electric powered thermometers that are left inside the food during cooking have been utilized as a solution but these problematically require large batteries or wires connected to a power source to be operational. Such devices need to be recharged often and/or plugged in during use. This typically is not feasible as the device is either be too large to fit the battery and/or wires are in the way of cooking. The extra batteries and wires also tend to create a messy environment and/or fire hazard. Even further, the devices sometimes run out of power during cooking. Therefore, an alternative wireless food probe system and/or method that solves these issues is desirable.

### SUMMARY

An exemplary embodiment of the present invention generally includes a wireless food probe utilizing Bluetooth Low Energy (“BLE”). In some embodiments a different wireless technology is utilized, such as regular Bluetooth, Wifi, or the like. Generally, various embodiments of the device include a BLE capable device comprising a main body with a handle, the main body including a printed circuit board (“PCB”) with a microcontroller, an antenna, and source of power.

In some embodiments, the wireless food probe of the present invention does not require external power or any kind of recharging. In such embodiments, the device is adapted to produce its required power for temperature measurement and wireless communications based on differential temperature inside the food item and the ambient temperature inside the heating cabinet. In some such embodiments, the main body includes one or more Resistance Temperature Detectors (“RTDs”). In some such embodiments, the main body includes a thermopile. In other such embodiments, a Peltier is used instead of or in addition to a thermopile. The difference in the temperatures is used to generate voltage through usage of thermopiles or a Peltier module, thereby charging a battery or directly powering the device.

In some embodiments, the wireless food probe includes a battery for power. In some such embodiments, the battery is located in the main body. In other embodiments, it is located in the handle. In some embodiments, the wireless food probe includes a receiving coil used to charge the battery through induction. In some such embodiments, the receiving coil is located in the main body. In other embodiments, it is located in the handle.

Some embodiments of the present invention further include an accompanying charging station utilizing transmitting coils for charging the probe. Some embodiments of the charging device are adapted for receipt of one or more probes and include a power supply, power regulator, one or more coils for charging the probes, LEDs to indicate probe charge level, and mounting brackets. In some embodiments the charging device is adapted for receipt of four probes.

In some embodiments, the wireless food probe of the present invention includes both the temperature differential power components, such as RTDs and thermopile/Peltier, and the battery power components, such as a receiving coil. In such embodiments, the charging station is optionally included. In some such embodiments, charging by temperature differential is preferred, with induction charging being utilized as back-up in the event sufficient temperature differential does not exist to recharge the battery or directly power the probe. In some embodiments the probes are capable of utilizing both power methods simultaneously and include all the components disclosed in connection with each.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF DRAWINGS

Embodiments of the present invention are described in detail below with reference to the attached drawing figures, wherein:

FIG. 1 shows a wireless food probe according to some embodiments of the present invention.

FIG. 2 shows a wireless food probe according to some embodiments of the present invention, with the exterior of the main body shell cut away for internal viewing.

FIG. 3 shows the internal components of a wireless food probe according to some embodiments of the present invention.

FIG. 4 shows a wireless food probe according to some embodiments of the present invention.

FIG. 5 shows a wireless food probe according to some embodiments of the present invention, with the handle hidden to show internal components.

FIG. 6 shows the internal components of a wireless food probe according to some embodiments of the present invention.

FIG. 7 shows a charging station according to some embodiments of the present invention that is in receipt of four food probes according to some embodiments of the present invention.

FIG. 8 shows a wireless food probe according to some embodiments of the present invention, with the handle hidden to show internal components.

### DETAILED DESCRIPTION OF THE INVENTION

As required, a detailed description of the various embodiments of the present invention are disclosed herein; however, it is to be understood that the disclosed embodiments are merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

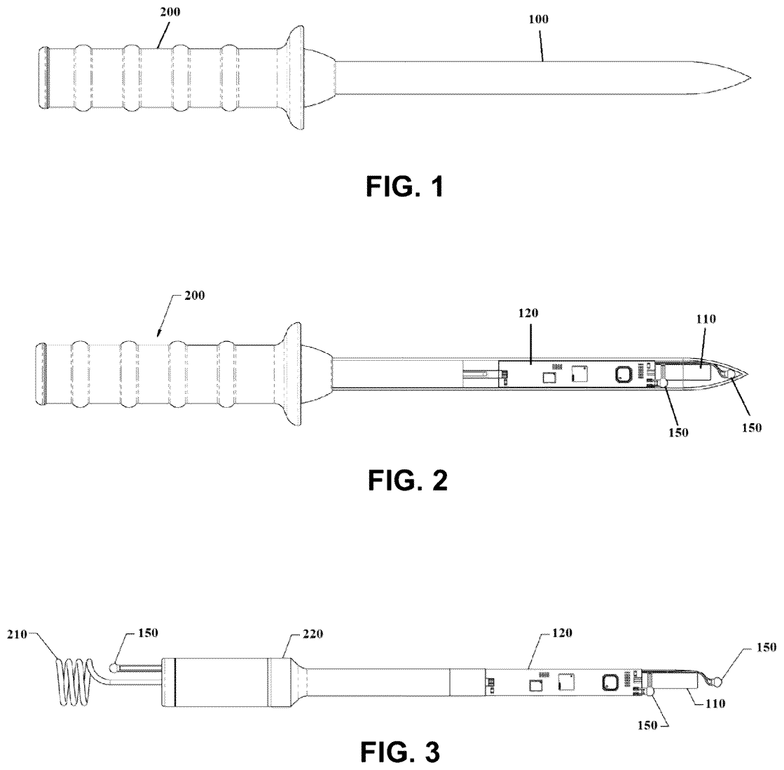

Looking to FIGS. 1-3, an exemplary wireless food probe of the present invention is shown. In the exemplary embodiment, the wireless food probe is adapted to produce its required power for temperature measurement and wireless communications based on the differential temperature. FIG. 1 shows the main body 100 and handle 200 of the probe. FIG. 2 shows inside the main body 100. Inside, the battery 110 and PCB 120 are shown. Additionally, two RTDs 150 are shown. FIG. 3 shows all the internal components with the exterior main body shell and handle being hidden. In addition to the two forward-located RTDs 150, a rear-located RTD is included. The antenna 210 and thermopile 220 are also shown. In other embodiments, a Peltier is used instead of or in addition to a thermopile. The difference in the temperatures at the various RTDs 150 is used to generate voltage through usage of thermopiles 220 or a Peltier module, thereby charging a battery 110 or directly powering the wireless food probe.

The wireless food probe is usable with food cooked in an oven or heating cabinet. Inside the oven or a heating cabinet, the ambient temperature of the cabinet is always much higher than inside the food item such as a steak, chicken, or the like. The main body 100 is inserted into a food item while the handle 200 remains exposed to the ambient temperature of the heating cabinet. The difference in the temperatures is used to generate voltage through usage of thermopiles or a Peltier module. The generated voltage is used through a voltage regulator and analyzer to charge a battery or a capacitor. The battery or capacitor is used to power a microcontroller responsible for temperature measurement and the BLE (or other suitable wireless) connection to transmit the data.

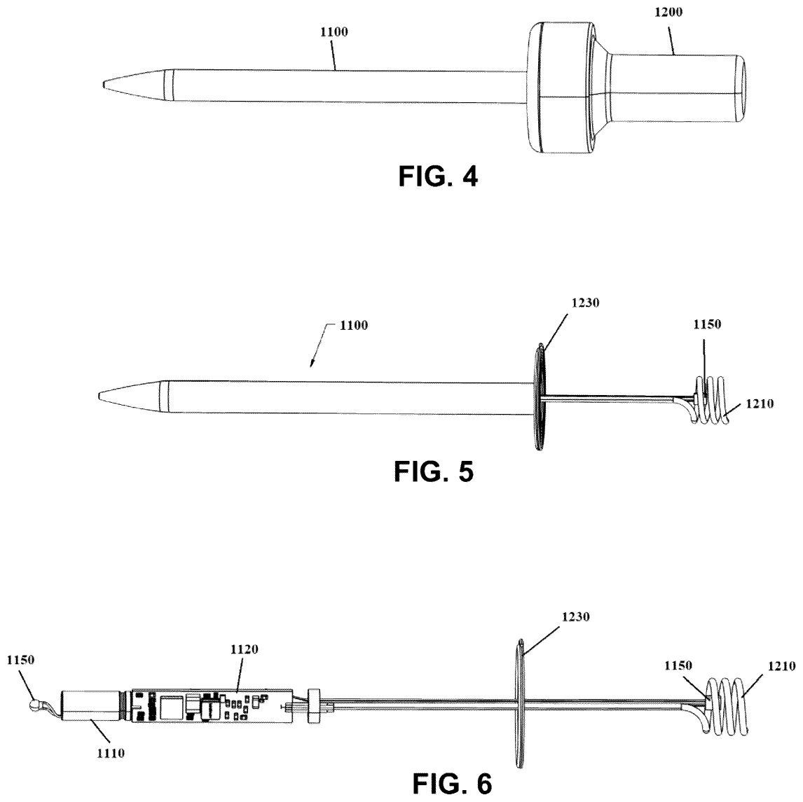

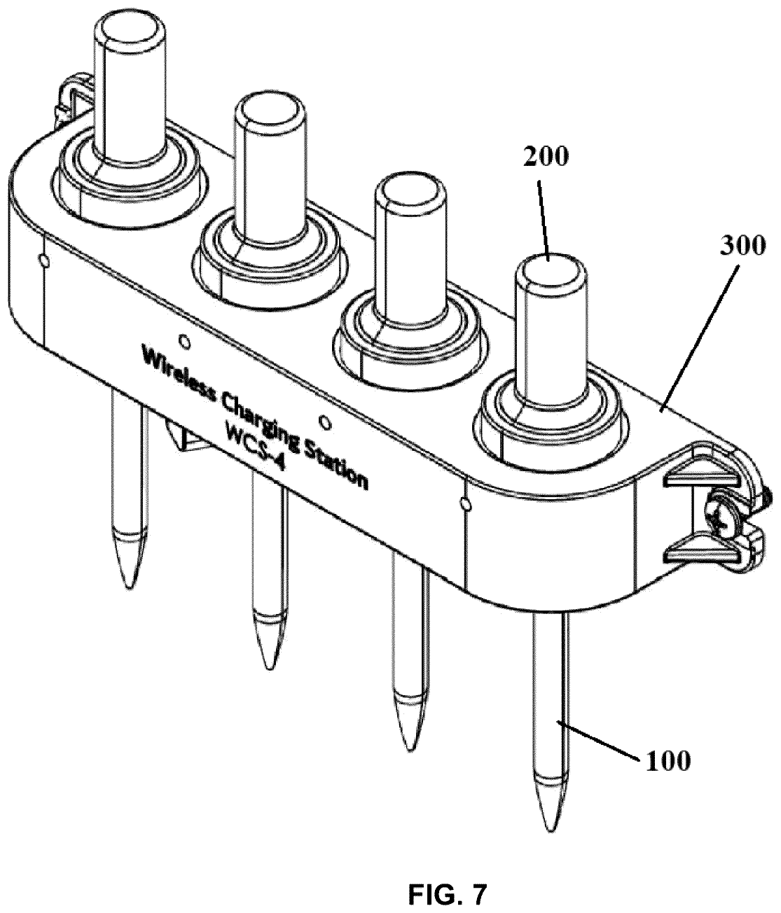

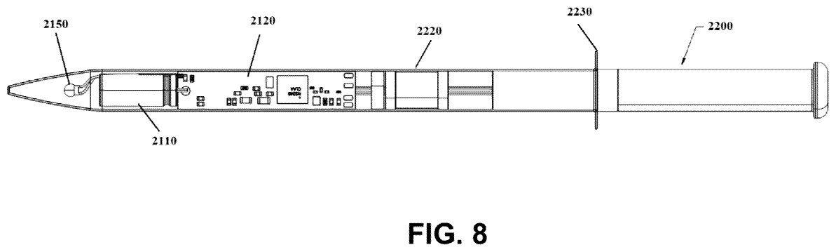

In some embodiments, such as shown in FIGS. 4-6, the present invention generally includes a wireless food probe utilizing a receiving coil for induction charging. The present invention further includes an accompanying charging station 300, shown in FIG. 7, utilizing transmitting coils for charging the probe. In some embodiments, the wireless food probe utilizes wireless technology, such as Bluetooth Low Energy (“BLE”), regular Bluetooth, Wifi, or the like.

Looking to FIGS. 4-6, an exemplary wireless food probe with induction charging capabilities is shown. FIG. 4 shows the main body 1100 and handle 1200 of the probe. FIG. 5 shows inside the handle 1200. Inside, the antenna 1210 and receiving coil 1230 are shown. Additionally, an RTD 1150 is shown. FIG. 6 shows all the internal components with the exterior main body shell and handle being hidden. In addition to the rear-located RTD 1150, a forward-located RTD 1150 is included. The battery 1110 and PCB 1120 are shown. In some embodiments a thermopile is used and in other embodiments a Peltier is used instead of or in addition to a thermopile. The difference in the temperatures at the various RTDs 1150 is used to generate voltage through usage of thermopiles 1220 or a Peltier module, thereby charging a battery 1110 or directly powering the wireless food probe. The receiving coil 1230 also recharges the battery when utilized with the charging station.

Some embodiments of the charging device are adapted for receipt of one or more probes and include a power supply, power regulator, one or more coils for charging the probes, LEDs to indicate probe charge level, and mounting brackets. In some embodiments the charging device is adapted for receipt of four probes, such as the charging station of FIG. 7.

Looking to FIG. 8, another embodiment of the wireless food probe with both temperature differential and induction charging capabilities is shown. In FIG. 8, the exterior of the probe is cut away and the internal components of the food probe are visible. FIG. 8 shows the interior of the main body and shows handle 2200 of the probe. The thermopile 2220 and receiving coil 2230 are shown. Additionally, an RTD 2150 is shown. At least one more RTD is included, but not visible in the drawing. The battery 2110 and PCB 2120 are shown. In some embodiments a thermopile is used and in other embodiments a Peltier is used instead of or in addition to a thermopile. The difference in the temperatures at the various RTDs 2150 is used to generate voltage through usage of thermopiles 2220 or a Peltier module, thereby charging a battery 2110 or directly powering the wireless food probe. The receiving coil 2230 also recharges the battery when utilized with the charging station.

In some embodiments, the receiving coil is located in the handle of the probe. When the probe is placed into the charging station, the receiving coil is then in communication with the corresponding transmitting coil of the charging station causing the probe to charge via induction. In some embodiments, the charging station is adapted to plug into a standard wall outlet. In some embodiments, the power supply is any DC power supply.

In some embodiments, the charging is station includes receptacles for insertion of the probes for charging. In some embodiments, the charging station is adapted for charging multiple probes simultaneously. In some embodiments, the number is four probes. In some embodiments, the charging station is mountable to the wall.

The battery or capacitor is used to power a microcontroller responsible for temperature measurement and the BLE (or other suitable wireless) connection to transmit the data.

The probe device is capable of communicating with any BLE enabled device or controller. Furthermore, in some embodiments, different communication methods are used. The device is configured to communicate with programs or applications on phones, tablets, computers, and the like. In some embodiments, the device of the present invention continuously broadcasts the live readings to the program or application for monitoring by the operator. In some embodiments, the program or application saves and stores the readings for later access. In some embodiments, temperature curves or graphs are generated and saved. In some embodiments, time stamp of measurements and other data is provided. In some embodiments, the operator is able to add certain comments, pictures, videos, or other details for each cooking session. In some embodiments, this data is timestamp according to the amount of time a food item has been cooking. In some embodiments, the saved data is shareable with others via an application, website, social media, or other means.

In some embodiments, the device of the present invention is configured to shut down when the temperature differential between the food item and the ambient becomes low and the battery discharges below the required voltage to keep the device alive. In some such embodiments, upon reaching the temperature difference again, the device powers up automatically and reconnects to its paired device; therefore, no manual reconnection is required. In some embodiments, as discussed in further detail below, the probe device is re-chargeable in the event the temperature differential becomes too low.

In some embodiments, the present invention has multiple temperature sensors inside its main body and it utilizes a method of averaging the readings to ensure the real temperature of the food item is taken. In some embodiments, four temperature sensors are used. As an example, if the device is inserted into a whole chicken where there is a gap of air inside the bird's stomach, the device detects that because of multiple sensor measurements and reports the meat temperature as opposed to the gap in the chicken stomach.

In some embodiments, a plurality of devices are utilized inside a single heating cabinet. In some such embodiments, colored cap of varying colors are screwed on top of each device to differentiate them. Colors of some embodiments include red, black, white, green, blue, yellow. In some such embodiments, the colored cap associated with a specific device is correlated to a display (controller, APP, computer dashboard). Therefore, for example, the display will show the temperature of the “blue” device on the screen. In some embodiments, engraved numbers, letters, or images are used.

In some embodiments, for safety reasons and to protect the integrity of the probe, a protective cap is provided that covers the tip of the probe.

In some embodiments, the handle of the device of the present invention uses ceramic or glass material for high temperature applications. Other materials are used in different embodiments. In some embodiments, the handle has a stopper that impacts the food when the probe is inserted into the food item. Taking advantage of a physical stopper as opposed to marking the device with a line, the end user does not need to think and watch where to stop when inserting the device into the food item.

It will be appreciated that the above also discloses a method for monitoring the temperature of the food. In some embodiments, the steps include inserting a probe into the food and the ambient temperature of the heating cabinet, utilizing the temperature differential to power a microprocessor and temperature sensor and BLE device, utilizing the microprocessor to control the temperature sensor and BLE device, utilizing the temperature sensors to read the temperature, and utilizing the BLE device to send the readings to a computer, application, or other device. It will be appreciated that other methods are disclosed herein.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

What is claimed is:

1. A wireless food probe, comprising:
an elongated main body, said main body including a pointed proximal end configured to be inserted into a food item;
a handle connected to the distal end of said main body;
a plurality of temperature sensors;
an antenna adapted to broadcast temperature information;
a battery;
an electronic device configured to charge the battery using energy created by the temperature differential between a food item and the ambient air; and
a printed circuit board including a controller.

2. The wireless food probe of claim 1, further including a receiving coil connected to the battery, said receiving coil configured to charge the battery via induction from an external power source.

3. The wireless food probe of claim 1, wherein said electronic device is a thermopile.

4. The wireless food probe of claim 1, wherein said electronic device is a Peltier device.

5. The wireless food probe of claim 1, wherein the temperature sensors are Resistance Temperature Detectors.

6. The wireless food probe of claim 1, wherein the handle includes a stopper.

7. The wireless food probe of claim 1, wherein there are four temperature sensors.

8. The wireless food probe of claim 1, wherein said controller is configured to track and record temperature information overtime.

9. The wireless food probe of claim 1, wherein the wireless food probe is configured to shut down when the temperature differential between the food item and the ambient becomes low and the battery discharges below the required voltage to keep the wireless food probe powered.

10. The wireless food probe of claim 9, wherein the wireless food probe is configured to power back on upon reaching the temperature difference again.

11. A wireless food probe system, the system comprising:
a wireless food probe comprising:
an elongated main body, said main body including a pointed proximal end configured to be inserted into a food item;
a handle connected to the distal end of said main body;
a plurality of temperature sensors;
an antenna adapted to broadcast temperature information;
a battery;
an electronic device configured to charge the battery using energy created by the temperature differential between a food item and the ambient air a receiving coil connected to said battery; and
a printed circuit board including a controller;
a charging station connected to a power source, said charging station comprising at least one receptacle adapted for receiving a wireless food probe, each receptacle including a transmitting coil; and
a Bluetooth enabled device adapted to receive temperature information broadcast by the antenna,
wherein said battery is configured to be charged (i) by the electronic device, and (ii) by induction between said transmitting coil and receiving coil.

12. The system of claim 11, wherein said electronic device is a thermopile.

13. The system of claim 11, wherein said electronic device is a Peltier device.

14. The system of claim 11, wherein the temperature sensors are Resistance Temperature Detectors.

15. The system of claim 11, wherein the Bluetooth enabled device includes a user interface configured to display temperature information.

16. The system of claim 11, wherein said charging station has four receptacles and is capable of charging four wireless probes simultaneously.

17. The system of claim 11, wherein said charging station is mountable to a wall.

18. A wireless food probe, comprising:
a plurality of temperature sensors;
an antenna adapted to broadcast temperature information;
a battery;
an electronic device configured to charge the battery using energy created by the temperature differential between a food item and the ambient air; and
a printed circuit board including a controller.

19. The wireless food probe of claim 18, further including a receiving coil connected to the battery, said receiving coil configured to charge the battery via induction from an external power source.

20. The wireless food probe of claim 18, wherein said electronic device is a thermopile.
